(19) United States
(12) Patent Application Publication
(10) Pub. No.: US 2026/0257263 A1
(43) Pub. Date: Sep. 3, 2026

(54) METAL PROCESSING METHOD AND METAL PROCESSING SYSTEM

(71) Applicant: H-ONE CO., LTD., Saitama-shi, Saitama (JP)

(72) Inventors: Daisuke Toyoda, Saitama (JP); Tatsuya Murano, Saitama (JP); Akihide Nagashima, Saitama (JP); Akira Umetsu, Saitama (JP)

(21) Appl. No.: 18/993,722

(22) PCT Filed: Jul. 21, 2023
(86) PCT No.: PCT/JP2023/026829

§ 371 Date: Jan. 13, 2025

(30) Foreign Application Priority Data
Jul. 22, 2022 (JP) 2022-117331

(51) Int. Cl. B21D 5/02

(52) U.S. Cl. CPC B21D 5/02

(57) ABSTRACT

A metal processing method includes a preparation step for preparing a raw material. The raw material integrally includes: a forming target portion to be press-formed into a product; a scrap portion to be eventually cut off and turned into scraps; and a test specimen portion provided in the scrap portion so as to be an object for a material characteristic test. The metal processing method further includes: a material characteristic test step for starting the material characteristic test by pressing the test specimen portion in a state where the forming target portion and the scrap portion are not yet cut off from each other; a recording step for recording measurement data in the material characteristic test step in association with the forming target portion; and a cut-off step for cutting off the forming target portion and the scrap portion from each other.

### TECHNICAL FIELD

The present invention relates to a metal processing method and a metal processing system.

### BACKGROUND ART

A conventional press-working apparatus which conducts metal processing includes: a pressurizer which has a die for forming a product by pressuring a plate-shaped metal material; a sensor which measures the state of the pressurizer; and a processor which processes inspection data measured by the sensor. For example, the processor determines the tendency of degradation of the press-working apparatus from the measured inspection data (see Patent Literature 1 and the like).

### CITATION LIST

### Patent Literature

Patent Literature 1: JP2019-107690

### SUMMARY OF INVENTION

### Technical Problem

In the case of forming a plurality of products by using a long metal material such as a coil material, even among materials within the same specification range, defective products are sometimes generated due to generation of a difference in material characteristics such as strength and extension.

However, it is difficult to determine whether the cause of generation of defective products is the die, or a problem of pressurization, or the characteristics of the material itself.

An object of the present invention is to provide a metal processing method and a metal processing system which are capable of virtually measuring material characteristics of a material which will be a product, and narrowing the cause of generation of a defective product, thereby improving the productivity.

### Solution to Problem

A metal processing method of the present invention comprises a preparation step of preparing a raw material integrally including a forming target portion which is press-formed to be a product, a scrap portion which is eventually cut off from the forming target portion to be a scrap, and a test specimen portion which is provided in the scrap portion and is subjected to a material characteristic test. The metal processing method comprises a material characteristic test step of starting a material characteristic test by pressing the test specimen portion in a state where the forming target portion and the scrap portion have not been cut off. Then, the metal processing method comprises: a recording step of recording measurement data of the material characteristic test step in association with the forming target portion; and a cut-off step of cutting off the forming target portion and the scrap portion from each other.

### Advantageous Effects of Invention

According to the present invention, it is possible to provide a metal processing method and a metal processing system which are capable of virtually measuring material characteristics of a material which will be a product, and narrowing the cause of generation of a defective product, thereby improving the productivity.

### BRIEF DESCRIPTION OF DRAWINGS

FIG. 1 is a schematic side view showing basic steps in a metal processing method and a metal processing system in a first embodiment of the present invention.

FIG. 2 is a schematic side view explaining major steps included in the metal processing system.

FIG. 3 is a block diagram explaining relations among the steps of the metal processing method.

FIG. 4 is a flowchart explaining each step of the metal processing method in sequential order.

FIG. 5 is a schematic side view showing steps of a metal processing method and a metal processing system of a second embodiment of the present invention and corresponding to FIG. 1.

FIG. 6 is a schematic side view showing steps of a metal processing method and a metal processing system of a third embodiment of the present invention.

FIG. 7 is a schematic side view showing steps of a metal processing method and a metal processing system of a fourth embodiment of the present invention.

FIG. 8 is a schematic side view showing steps of a metal processing method and a metal processing system of a fifth embodiment of the present invention.

FIG. 9 is a block diagram showing steps of a metal processing method and a metal processing system of a sixth embodiment of the present invention.

FIG. 10 is a schematic side view showing the steps of the metal processing method and the metal processing system of the sixth embodiment.

FIG. 11 is a schematic side view explaining steps of a metal processing method and a metal processing system of a seventh embodiment.

### DESCRIPTION OF EMBODIMENTS

Hereinafter, metal processing methods and metal processing systems of embodiments of the present invention will be described with reference to the drawings as appropriate. Note that each of the following drawings mainly shows arrangement relations among the portions schematically. For this reason, the relative sizes exhibited by the respective portions may be different from the actual sizes in some cases. In addition, the same constituent elements are denoted by the same reference signs, and repetitive descriptions are omitted.

### First Embodiment

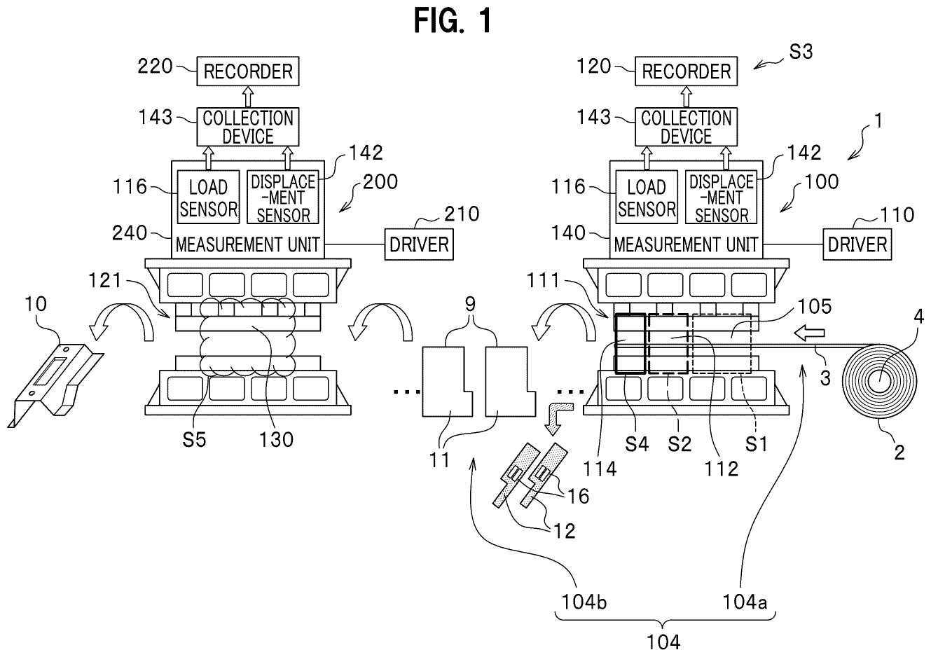

As shown in FIG. 1, a metal processing system 1 of a first embodiment mainly includes an uncoiler 4 which supports a raw material made of a metal, a first press-working machine 100, a second press-working machine 200, and a transporter 104.

The uncoiler 4 of the metal processing system 1 has a rotatable cylindrically shaped cylinder. On the cylinder, a coil material 2 made of a metal as a raw material is wound. The coil material 2 pulled out of the uncoiler 4 is expanded into a flat plate-shaped raw material 3.

The transporter 104 has a first transporter 104a between the uncoiler 4 and the first press-working machine 100. The first transporter 104a has a leveler feeder or the like and transports the raw material 3 expanded into a flat shape to the first press-working machine 100. Inside the first press-working machine 100, a test specimen portion former 105, a material characteristic tester 112, and a cutter 114, which will be described later, are disposed.

The raw material 3 is transported by the first transporter 104a sequentially to the test specimen portion former 105, the material characteristic tester 112, and the cutter 114 inside the first press-working machine 100 to be intermediate products 11.

In addition, the transporter 104 has a second transporter 104b between the first press-working machine 100 and the second press-working machine 200. The second transporter 104b has a conveyor or the like and transports the intermediate products 11 from the first press-working machine 100 into the second press-working machine 200.

In the second press-working machine 200, a press former 130 is disposed. The press former 130 sequentially press-works the intermediate products 11 to manufacture a plurality of products 10. Here, press working includes at least one of press forming and blanking. Hereinafter, press forming or blanking is referred to simply as press working in some cases. Moreover, the transporter 104 may be configured to transport a press-worked product 10 out of the second press-working machine 200.

### [Press-Working Machine]

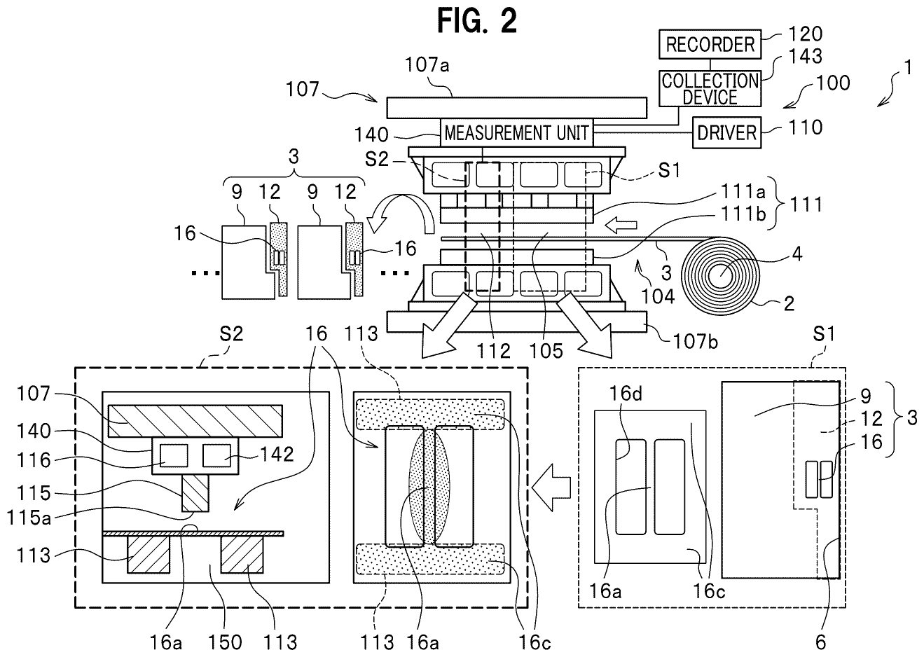

As shown in FIG. 2, the first press-working machine 100 of the first embodiment includes a first die 111 which is used to press-work the flat plate-shaped raw material 3 to manufacture the intermediate product 11. In addition, the first press-working machine 100 mainly includes a die supporter 107 which is used to detachably mount one or two or more dies and the like on the first press-working machine 100, and a first driver 110 which drives the first die 111 and the like together with the die supporter 107 to open and close in a vertical direction.

The first die 111 is configured with an upper die 111a and a lower die 111b. The upper die 111a and the lower die 111b are supported respectively on an upper slide 107a and a bolster 107b which constitute the die supporter 107. Note that FIG. 2 schematically shows relative arrangement relations among the portions. For this reason, the proportions of the sizes of the upper slide 107a and the bolster 107b to the die supporter 107, the first driver 110, the upper die 111a and the lower die 111b of the first die 111 are different from the actual proportions. For example, the upper slide 107a and the bolster 107b are further larger than the first die 111.

In addition, the second press-working machine 200 shown in FIG. 1 mainly includes a second die 121, and a second driver 210 which drives the second die 121 to open and close in the vertical direction. Among these, the second die 121 includes the press former 130 which is used to press-form a forming target portion 9 of the intermediate product 11. The press former 130, note that the second press-working machine 200 may include a slide on which the die 121 is detachably mounted, like the first press-working machine 100. Then, the second press-working machine 200 drives the second die 121 to open and close by means of the driver 210 to manufacture a product 10 having a desired shape from the intermediate product 11.

### [Driver]

The driver 110, 210 conducts a closing operation, for example, by causing the upper die 111a to descend and approach to the lower die 111b. In addition, the driver 110 conducts an opening operation to cause the upper die 111a to ascend and move away from the lower die 111b. In this way, the first die 111 conducts the press working by moving opposed surfaces of the upper die 111a and the lower die 111b toward and away from each other in the vertical direction on the raw material 3 interposed therebetween. In the press working, the raw material 3 is pressed in the vertical direction in association with the closing operation to conduct a bending and forming process (form process) or a drawing process (draw process) as the press forming. In addition, as the press working, a die-cutting process (hereinafter also referred to as blanking or blanking process), a shearing process, or the like is conducted. The drive system of the driver 110, 210 may be any of three systems, a mechanical system, a hydraulic system, and a servo system.

Note that the configuration is not limited to this, and the press working may be conducted by the driver 110, 210 driving the upper die 111a and the lower die 111b to cause the opposed surfaces to move toward or away from each other.

### [Recorder]

In addition, as shown in FIG. 1, the first press-working machine 100 includes a recorder 120 and a measurement unit 140. The measurement unit 140 measures the distance between the upper die and the lower die to detect the opening or closing operation of the die 111. Then, the recorder 120 records measurement data of the material characteristic tester 112 in association with the forming target portion 9. Specifically, the recorder 120 records measurement data on a deformation amount of the test specimen portion 16 which is measured by the measurement unit 140 in association with the forming target portion 9 which is disposed adjacent thereto before cut-off along with the opening or closing operation of the driver 110.

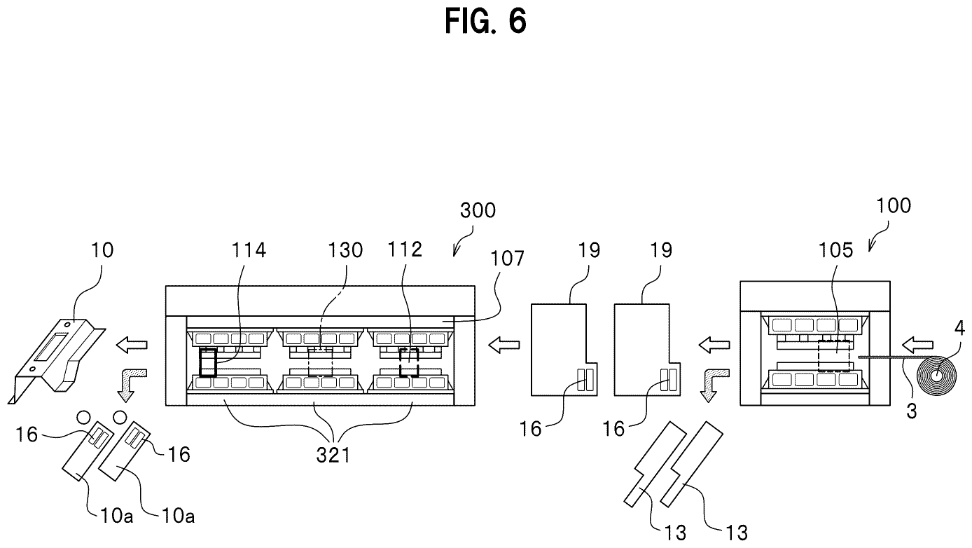

Note that as shown in FIG. 1, the material characteristic tester 112 and the recorder 220 may be provided in the second press-working machine 200 or the like. By providing the recorder 220 in a second press-working machine 300 (see FIG. 6 or the like) or the like of a third embodiment or the like, measurement data can be recorded in association. For example, manufactured products 10 or forming target portions 9 (see FIG. 2), which will be intermediate products, may be stacked in sequence, which then can be checked on a one-to-one basis with measurement data stored in production order.

The first press-working machine 100 and the second press-working machine 200 of the metal processing system 1 of the first embodiment execute each step, which will be described later, in conducting the press working by driving the respective dies 111 and 121 to open and close.

The first press-working machine 100 includes a test specimen portion former 105 which conducts a material characteristic test preparation step S1, a material characteristic tester 112 which conducts a material characteristic test step S2, and a cutter 114 which conducts a cut-off step S4.

Then, the raw material 3 transported by the first transporter 104a is inserted sequentially through the test specimen portion former 105, the material characteristic tester 112, and the cutter 114, which are arranged sequentially from the uncoiler 4 side.

The driver 110 of the first embodiment drives the die 111 to open and close once or a plurality of times in one cycle of the first press-working machine 100. Then, the first press-working machine 100 can simultaneously conduct the formation of the test specimen portion 16 using the test specimen portion former 105, the characteristic test on the test specimen portion 16 using the material characteristic tester 112, and the cut-off process using the cutter 114 on a plurality of portions (three portions in the first embodiment) of the raw materials 3 through one opening and closing drive.

Here, “one cycle” includes the following. That is, “one cycle” includes a case where the die 111 is driven to open and close a plurality of times for working by opening and closing drive by a drive source such as a servo motor of the driver 110. In addition, “one cycle” includes a case where the timings of press motions are shifted, for example, motions such as temporarily halting individually or simultaneously. In this way, “one cycle” indicates a series of actions which are conducted from when the raw material 3 is transported into each step to when the raw material 3 is moved to the next step, such as, for example, a period when the raw material 3 is moved from the preparation step S1 to the material characteristic test step S2.

### [Test Specimen Portion Former]

The first press-working machine 100 of the first embodiment conducts the preparation step S1 in the test specimen portion former 105 in the die 111. The preparation step S1 includes a test specimen portion forming step of forming the test specimen portion 16 having a shape suitable for the material characteristic test from the raw material 3.

As shown in FIG. 2, in the test specimen portion forming step, the first press-working machine 100 drives the driver 110 to drive the die 111 to close. This forms the forming target portion 9 having a predetermined shape which will become the product 10 or the intermediate product 11, and a scrap portion 12 which will not become the forming target portion 9, in the raw material 3.

As shown in FIG. 2, in the test specimen portion forming step of the preparation step S1, the test specimen portion 16 is formed in the scrap portion 12 which continues to the forming target portion 9 before being formed as the product 10. The test specimen portion 16 is formed at a position adjacent to the forming target portion 9 at a substantially center in a longitudinal direction of the scrap portion 12, for example.

The test specimen portion 16 of the first embodiment has a long plate-shaped test piece 16a, a die contact portion 16c at which the test specimen portion 16 is fixed, and a test hole 16d having an opening in which the test piece 16a is disposed. Among these, opposite end portions of the test piece 16a in the longitudinal direction are connected to the respective side edges opposite to each other in the periphery of the test hole 16d. Then, the test piece 16a is configured to bend and extend when pressed by a lower end 115a of a punch portion 115, which will be described later. Note that the test piece 16a of the test specimen portion 16 does not have to have a constant width, and may have any shape such as a cross shape or a rhombus shape, for example. In this case, at least one end portion of the test piece 16a is connected to one of the side edges of the test hole 16d.

In addition, the test hole 16d of the first embodiment is a hole having a substantially rectangular shape in plan view. However, the shape of the test hole 16d may be any shape such as a circular hole shape, an elliptical shape, an oval shape, or a polygonal shape, for example. That is, the shapes, numbers, and arrangement positions of the test piece 16a and the test hole 16d may be any shapes, numbers, and arrangement positions.

### [Material Characteristic Tester]

As shown in FIG. 2, the material characteristic tester 112 of the first embodiment is arranged adjacent to the test specimen portion former 105 on the downstream side in the traveling direction of the raw material 3 in the first press-working machine 100 like the other die and the like.

Then, the raw material 3 is transported from the test specimen portion former 105 into the material characteristic tester 112 in the state where the forming target portion 9 and the scrap portion 12 have not been cut off. The scrap portion 12 is positioned at a predetermined position in the material characteristic tester 112.

The material characteristic tester 112 has the punch portion 115, which serves as a pressing portion for pressing the test specimen portion 16 formed in a predetermined shape, and a die portion 113, which is disposed on the opposite side to the punch portion 115. In addition, the material characteristic tester 112 has the measurement unit 140 which measures at least one of a reaction force or a deformation amount generated by pressing the test specimen portion 16.

Among these, the punch portion 115 is capable of moving in the vertical direction along with the opening and closing drive of the upper die 111a with its axial direction being aligned with the vertical direction. Then, the lower end 115a of the punch portion 115 is configured to come into contact with the test piece 16a of the test specimen portion 16 positioned at the predetermined position. In addition, the shape of the punch portion 115 or the die portion 113 is not particularly limited to the shape shown in the embodiment. That is, any other shape may be used as long as the shape allows the punch portion 115 or the die portion 113 to at least partially come into contact with and press the test piece 16a, and the shape, number, and arrangement position of the punch portion 115 or the die portion 113 may be configured to be any shape, number, and arrangement position.

The measurement unit 140 includes a displacement sensor 142 which measures the deformation amount of the test piece 16a. Here, the displacement sensor 142 may be provided in such a manner as to indirectly measure the positional relation between the test piece 16a and the punch portion 115. That is, the displacement sensor 142 may measure any distance between two points as long as at the position, the displacement sensor 142 can indirectly measure the positional relation between the test piece 16a and the punch portion 115, such as the distance between the upper die 111a and the lower die 111b or the distance between the upper slide 107a and the bolster 107b.

In addition, the measurement unit 140 includes a load sensor 116. The load sensor 116 measures a pressing force which is generated when the lower end 115a of the punch portion 115 comes into contact with the test piece 16a.

The deformation amount and the pressing force measured by the displacement sensor 142 and the load sensor 116 are sent as measurement data to a collection device 143 which is electrically connected, and are recorded by the recorder 120.

The measurement unit 140 has only to measure at least one of the deformation amount and the pressing force, and for the deformation amount, for example, an approach of calculating the deformation amount from the stroke amount of the pressing machine or the like may be used.

On the other hand, a pair of the die portions 113, 113 are provided in parallel at a predetermined interval in the lower die 111b below the punch portion 115.

The pair of die portions 113, 113 support a pair of die contact portions 16c, 16c which are formed on an inner periphery of the test hole 16d from below, respectively. Then, in the material characteristic tester 112, when the punch portion 115 is caused to descend, the punch portion 115 brings the lower end 115a into contact with the upper surface of the test piece 16a to bend and press downward the test piece 16a (see FIG. 2).

At this time, a space 150 has been formed between the pair of die portions 113, 113. For this reason, the test specimen portion 16 is allowed to deform to go down into the space 150 without interfering with the surrounding members. The measurement unit 140 measures the deformation amount of the test piece 16a and the measurement value of the load sensor 116.

### [Cut-Off Portion]

As shown in FIG. 1, the cutter 114 conducts the cut-off step of cutting off the forming target portion 9 and the scrap portion 12 from each other after the recorder 120 records the measurement data in association with the forming target portion 9.

In the first embodiment, the forming target portion 9 and the scrap portion 12 are separated from each other. In the recorder 120, measurement data of the test specimen portion 16 has been recorded in association with the corresponding forming target portion 9 in advance. The forming target portion 9 cut off is transported to the next step in a managed state. On the other hand, the scrap portion 12 falls into a shoot which is not shown and is discarded.

For this reason, the metal processing system of the present embodiment can easily judge whether or not the material characteristics of the product 10 formed in the forming target portion 9 is favorable in association with the measurement data.

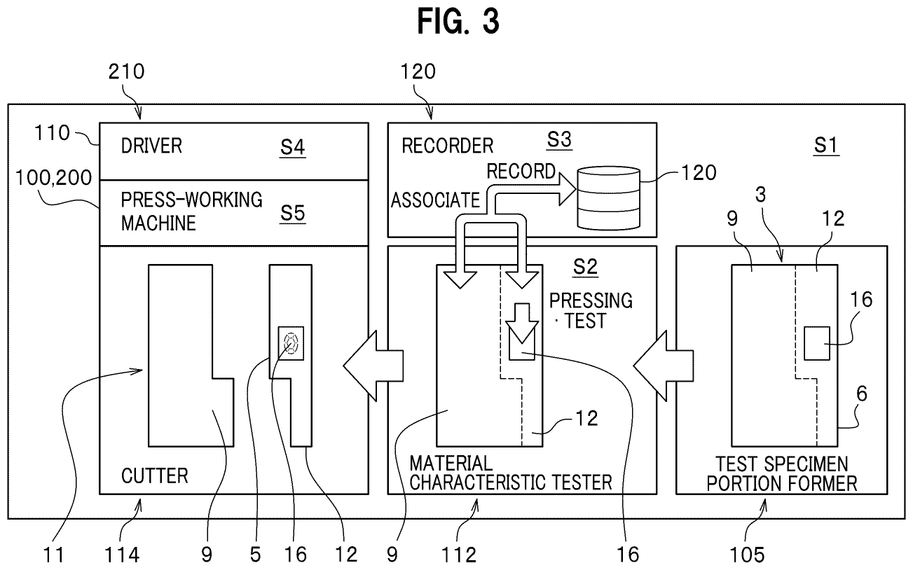

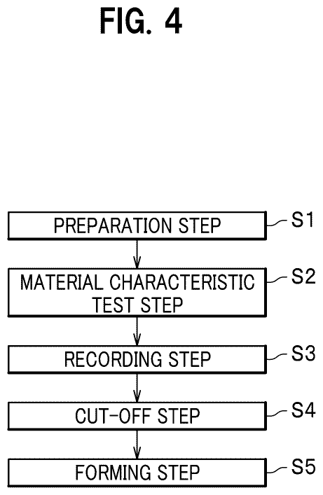

Next, each step of the metal processing method and the metal processing system of the present embodiment will be described along with a flowchart of FIG. 4 while referring to FIG. 3.

### [Preparation Step]

First, in FIG. 4, in step S1, once the preparation step is started, a test specimen portion is formed in the preparation step by using the first press-working machine 100 (see FIGS. 1, 2) provided with the test specimen portion former 105.

In the preparation step, the test specimen portion 16, which will be subjected to the material characteristic test, is formed in the scrap portion 12 by the test specimen portion former 105.

At this time, the test specimen portions 16 may be formed sequentially in a test specimen portion forming region where a plurality of the raw materials 3 are continuously transported and aligned to be subjected to different processes in the first press-working machine 100.

In this way, the forming target portion 9 and the test specimen portion 16 of the scrap portion 12 is formed in one cycle in the first press-working machine 100.

Then, the scrap portion 12 including the test specimen portion 16 and the forming target portion 9 are transported to the material characteristic tester 112 by the first transporter 104a while not being cut off but being integral with each other.

### [Material Characteristic Test Step]

In step S2, the material characteristic test step is conducted by the material characteristic tester 112 provided in the first press-working machine 100. The material characteristic tester 112 of the first embodiment conducts the test of measuring material characteristics by using the test specimen portion 16 of the scrap portion 12 thus transported.

In the material characteristic test step, the die contact portions 16c, 16c of the test specimen portion 16 are locked respectively to the pair of die portions 113, 113, so that the test piece 16a is disposed at a position facing the lower end 115a of the punch portion 115 (see FIG. 2).

As shown in FIG. 2, when the punch portion 115 descends and the lower end 115a thus comes into contact with and presses the test piece 16a, a pressing force is measured by the load sensor 116. At this time, the test specimen portion 16 has been formed in part of the scrap portion 12 in the state of being disposed adjacent to the forming target portion 9 and not cut off. For this reason, the metal processing system conducts the material characteristic test on the test specimen portion 16 which has substantially the same material characteristics as those of the forming target portion 9, which will be the product 10. This allows the metal processing system to measure the same material characteristics as those of the forming target portion 9 from the scrap portion 12.

Moreover, the metal processing system 1 of the first embodiment shown in FIG. 2 is such that the material characteristic test step is executed in the material characteristic tester 112. The material characteristic tester 112 is provided in the die of the first press-working machine 100. For this reason, the material characteristics of the test specimen portion 16 can be measured by using the die clamping action of the die by the first press-working machine 100.

Therefore, it is unnecessary to take out the test specimen portion 16 from the first press-working machine 100. In addition, another material characteristic testing apparatus is unnecessary and the manufacturing cost can be suppressed.

### [Recording Step]

In step S3, the recording step is conducted by the recorder 120. In the recording step, the recorder 120 records the measurement data measured in the material characteristic test step S2 of the first press-working machine 100 in association with the corresponding forming target portion 9.

In addition, in the first embodiment, the test piece 16a moves in the pressing direction while bending and deforming depending on the opening and closing drive amount of the driver 110 shown in FIG. 2. Then, both the deformation amount and the pressing force are continuously measured from immediately before the contact of the punch to when the test specimen portion 16 is finally broken, and from the entire measured data, a plurality of material characteristic values are calculated and recorded by the recorder 120. This makes it possible to obtain the relation between the deformation amount and the pressing force and to thus obtain the material characteristics of the raw material 3.

### [Cut-Off Step]

In step S4, the cut-off step is conducted by using the cutter 114. In the cutter 114, the die 111 is driven to open and close by the driver 110 in such a manner as to move toward and away from the raw material 3.

In the first press-working machine 100 of the first embodiment, once the die 111 is closed by the drive of the driver 110, the intermediate product 11 and the scrap portion 12 on which the measurement data has already been recorded by the recorder 120 are cut off by the cutter 114. The intermediate product 11 includes the forming target portion 9.

At this time, a plurality of the raw materials 3 are continuously transported in the first press-working machine 100, and aligned and sequentially subjected to cut-off processes in a plurality of cut-off process regions where different cut-off processes are conducted. Note that the cut-off process regions may be provided in one process region in a manner that the cut-off process regions are overlapped with the test specimen portion forming region.

In this way, in the metal processing system 1 of the first embodiment shown in FIG. 1, the preparation step, the material characteristic test step, and the cut-off step can be conducted in one cycle in which the driver 110 of the first press-working machine 100 drives the die 111 to open and close.

### [Forming Step]

In step S5, the forming step of processing the intermediate product 11 as the product 10 is conducted by using the second press-working machine 200.

The second press-working machine 200 of the first embodiment shown in FIG. 1 drives the press former 130, which is provided in the second die 121, to open and close in approaching and separating directions by using the driver 210. The forming target portion 9 transported into the second die 121 is press-formed and completed as the product 10. Note that the press working may be conducted on the forming target portion 9 in the material characteristic test step S2 or the cut-off step S4.

In this way, the metal processing system and the metal processing method of the first embodiment can virtually measure the material characteristics of a material which will be the product 10, narrow the cause of generation of a defective product, shorten the time required for determination, and reduce the generation of defects, thereby improving the productivity as a whole.

Specifically, the test specimen portion 16 shown in FIG. 1 is provided in the scrap portion 12 in the state where the forming target portion 9, which will be the product 10, and the scrap portion 12 have been integrally formed and not been cut off. Moreover, in the first embodiment, as shown in FIG. 2, the test specimen portion 16 of the scrap portion 12 is formed adjacent to the forming target portion 9.

For this reason, the metal processing system 1 can obtain material characteristics equivalent to the material characteristics of the forming target portion 9, which will be the product 10, by measuring the test specimen portion 16. The measurement data thus measured is recorded in the recorder 120 in association with the forming target portion 9.

For example, in the case of forming a plurality of products 10 by using a long metal material such as the coil material 2, even among materials within the same specification range, defective products are sometimes generated due to generation of a difference in material characteristics such as strength and extension.

Even in such a case, in the metal processing system and the metal processing method of the first embodiment, measurement data measured is recorded in the recorder 120 corresponding to each product 10. For this reason, in the metal processing system of the first embodiment, one of causes of generation of defective products can be eliminated first as to whether or not a defect is caused by a material.

Then, it becomes possible to easily narrow and determine whether the cause of generation of defective products is the second die 121 or a problem of pressurization of the second press-working machine 200, and to thus improve the productivity.

The metal processing system 1 can conduct the preparation of the raw material 3 by the preparation step, the material characteristic test by the material characteristic test step, and cut-off of the scrap portion 12 from the forming target portion 9 by the cut-off step by means of the opening and closing drive of the die 111 in one cycle. For this reason, the metal processing system 1 can execute the material characteristic test without lowering the productivity.

Then, the metal processing system 1 can press-form only the forming target portion 9 of the intermediate product 11 by using the second press-working machine 200, which is the second machine. For this reason, there is no influence of stress and the like which would be generated by simultaneously pressurizing the scrap portion 12.

Moreover, since the pressing test of material characteristics is not conducted directly on the forming target portion 9, no signature of the measurement remains in the product. Therefore, the metal processing system 1 can measure material characteristics without impairing the appearance quality of the product 10.

In addition, it is unnecessary to separately provide another measurement apparatus other than the opening and closing die. Hence, the manufacturing line is simplified, and an increase in manufacturing cost can be suppressed.

Normally, as a method for evaluating the characteristics of a material, there is a method including: blanking an intermediate product 11; processing the intermediate product 11 into a test piece shape by using a machine outside the manufacturing line; and further executing a tensile test by using a universal material testing machine, and the like. In this way, since in the current processing step, a test is separately conducted, and it is necessary to cut off a material and conduct the test in another place in order to find material characteristics.

In the metal processing system of the embodiment, it is possible to conduct the material test during the processing step by providing the test piece 16a in the scrap portion 12 utilizing a conventional die and an empty space between steps. In this way, in the embodiment, it is possible to immediately find material characteristics even without conducting a test in particular, and thus, at the time when defective products are generated, and the like, check the material characteristics and narrow the cause of generation.

Then, at least two steps among the test specimen portion forming step, the material characteristic test step, and the cut-off step are executed on each raw material 3 placed in each step in one cycle in the first press-working machine 100. In the first embodiment, three steps of the test specimen portion forming step, the material characteristic test step, and the cut-off step included in the preparation step are executed in one cycle in the single first press-working machine 100.

Therefore, even when the steps increase, an increase in the number of the first press-working machine 100 can be suppressed.

Moreover, in the material characteristic test step, the material characteristics of the test specimen portion 16 can be measured by using the die clamping action of the press forming step of conducting the press forming.

Hence, another measurement device such as an apparatus that presses the test specimen portion 16 or performs another action becomes unnecessary, and the number of apparatuses can be reduced to suppress the cost.

In addition, the first transporter 104a of the transporter 104 transports the raw material 3 from the material characteristic tester 112 to the cutter 114. In the metal processing system 1 of the first embodiment shown in FIG. 1, the first transporter 104a sequentially transports the raw material 3, which is pulled out of the uncoiler 4, to the test specimen portion former 105, the material characteristic tester 112, and the cutter 114 of the first press-working machine 100.

In addition, the second transporter 104b transports a plurality of intermediate products 11, from each of which the scrap portion 12 is separated in the first press-working machine 100, to the second press-working machine 200. The intermediate products 11 are each press-formed in the second die 121 by the opening and closing drive of the driver 210 of the second press-working machine 200, so that a plurality of products 10 are manufactured.

In the recorder 120, 220 of the metal processing system 1, material characteristics corresponding to each product 10 are stored as measurement data. For this reason, the transporter 104 can sequentially transport a plurality of products 10 out without mixing up measurement data of a generated defective product with measurement data of another product 10.

### Second Embodiment

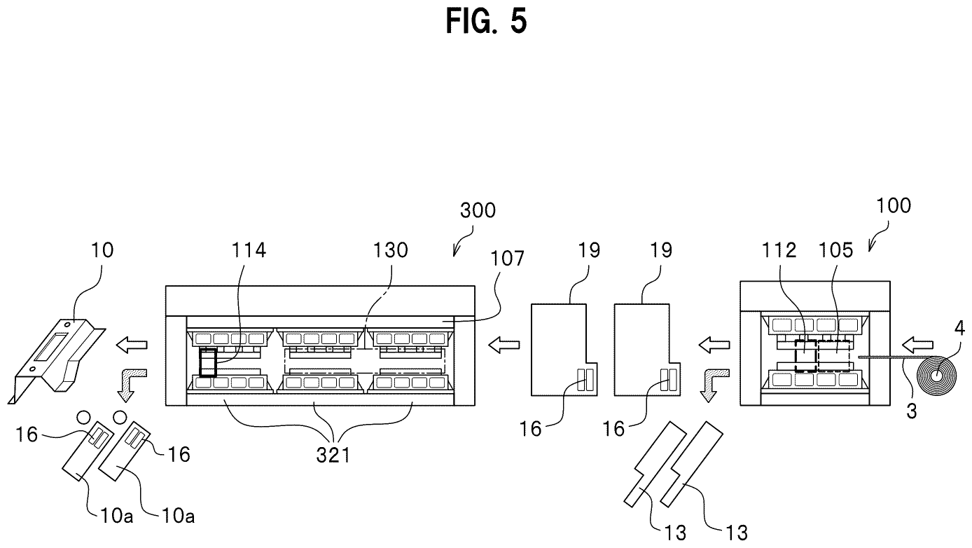

FIG. 5 shows a metal processing method and a metal processing system of a second embodiment. Note that parts identical or equivalent to those of the first embodiment are denoted by the same reference signs, and different parts will be mainly described.

Note that a first press-working machine 100 and a second press-working machine 300 of the second embodiment have drivers (not shown) equivalent to the first driver 110 and the second driver 210 shown in FIG. 1, respectively. In addition, although not shown for simplification of the description, the same applies to third to seventh embodiments, which will be described later. Moreover, in the second press-working machines 300 of the third to seventh embodiment, what correspond to the recorder 220 and deformation amount measurer 240 of the first embodiment are provided as appropriate in the material characteristic tester 112 together with the driver 210 shown in FIG. 1.

In the second embodiment, the forming target portion 19 and the scrap portion 10a are transported to a second press-working machine 300 while being coupled together. Then, the second embodiment is different from the first embodiment in that the scrap portion 10a is cut off when the forming target portion 19 is press-worked in the second press-working machine 300.

As shown in FIG. 5, the first press-working machine 100 moves the material characteristic tester 112 toward and away from the raw material 3. The forming target portion 19 which has undergone the formation of the test specimen portion 16 by the test specimen portion former 105 and the material characteristic test step by the material characteristic tester 112 is transported to the second press-working machine 300 while having the test specimen portion 16. Note that at this time, part of the scrap portion 13 where the test specimen portion 16 is not formed may be separated by cutting off.

The second press-working machine 300 of the second embodiment includes a cutter 114 which conducts the cut-off step and a press former 130 which conducts the forming step. In the second press-working machine 300, the cutter 114 and the press former 130 are configured by using a plurality of dies 321. Then, the second press-working machine 300 moves the cutter 114 toward and away from the forming target portion 19.

Among these, the press former 130 press-forms the product 10 from the forming target portion 19. In addition, a remaining scrap portion 10a in which the test specimen portion 16 has been formed is separated from the product 10 by the cutter 114 of the second press-working machine 300. For this reason, the test specimen portion 16 does not remain in the product 10.

In the metal processing method and the metal processing system of the second embodiment, the test specimen portion 16 is formed in the raw material 3 by the test specimen portion former 105, and the material characteristic test step is conducted by the material characteristic tester 112 in the first press-working machine 100.

In addition, the second press-working machine 300 executes two steps of the press forming step and the cut-off step in one cycle.

For this reason, since the material characteristic test step and the cut-off step are individually executed by driving the respective drivers of the first press-working machine 100 and the second press-working machine 300, the production efficiency does not decrease.

In this way, in the second embodiment, increases in the numbers of the first press-working machine 100 and the second press-working machine 300 can be suppressed like the first embodiment.

The other configurations as well as actions and effects are the same as those of the first embodiment, and thus are not described.

### Third Embodiment

A metal processing system of a third embodiment shown in FIG. 6 includes the material characteristic tester 112 provided in the second press-working machine 300. Then, the metal processing system of the third embodiment is configured such that the second press-working machine 300 can simultaneously execute the material characteristic tester 112, the press former 130, and the cutter 114 by the opening and closing drive in one cycle. Note that parts identical or equivalent to those of the first and second embodiments are noted by the same reference signs, and different parts will be mainly described.

In the third embodiment, the material characteristic tester 112 is provided in the second press-working machine 300 including the press former 130 which conducts press forming on the forming target portion 19 as shown in FIG. 6. For this reason, it is possible to press the test specimen portion 16 to conduct the material characteristic test at the same timing as the press-forming of the forming target portion 19 by the press former 130.

In this way, when the product 10 is formed by the die, material characteristics equivalent to those of the raw material 3 constituting the product 10 can be simultaneously measured.

In the material characteristic test step of the third embodiment, material characteristics of the test specimen portion 16 can be measured by using the die clamping action of the press forming step of conducting the press forming. Therefore, another apparatus that separately presses the test specimen portion or performs another action becomes unnecessary, and the number of apparatuses can be reduced to suppress the cost.

The other configurations as well as actions and effects are the same as those of the first and second embodiments, and thus are not described.

### Fourth Embodiment

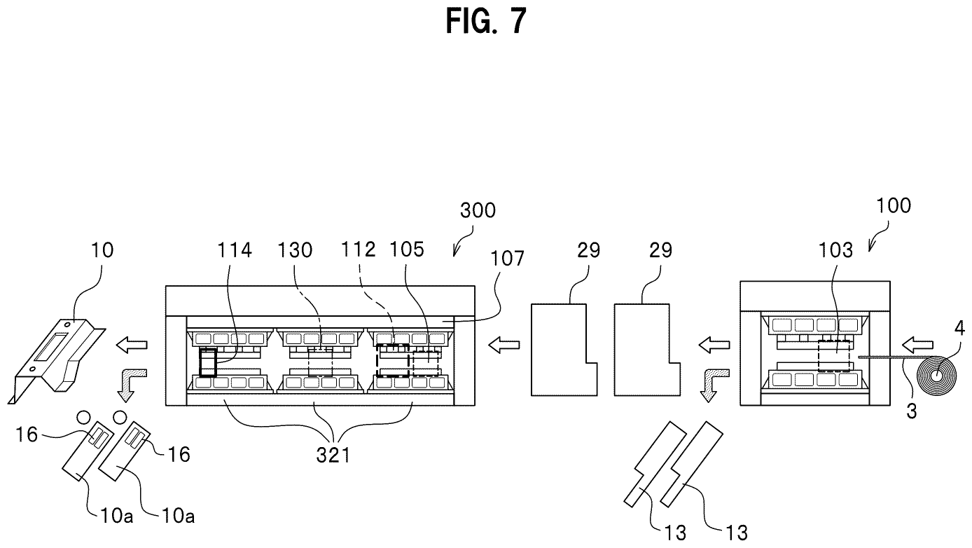

FIG. 7 shows a metal processing system of a fourth embodiment. Note that parts identical or equivalent to those of the first embodiment are denoted by the same reference signs, and different parts will be mainly described.

In the fourth embodiment, a forming target portion former 103 which executes a forming target portion forming step among the preparation step is disposed in the first press-working machine 100. In addition, in the fourth embodiment, the test specimen portion former 105 which executes the test specimen portion forming step among the preparation step is disposed in the second press-working machine 300.

This makes it possible to simultaneously execute the test specimen portion forming step and the material characteristic test step on the intermediate product 11 by a single opening and closing drive in the same second press-working machine 300. The other configurations as well as actions and effects are almost the same as those of the third embodiment, and thus are not described.

### Fifth Embodiment

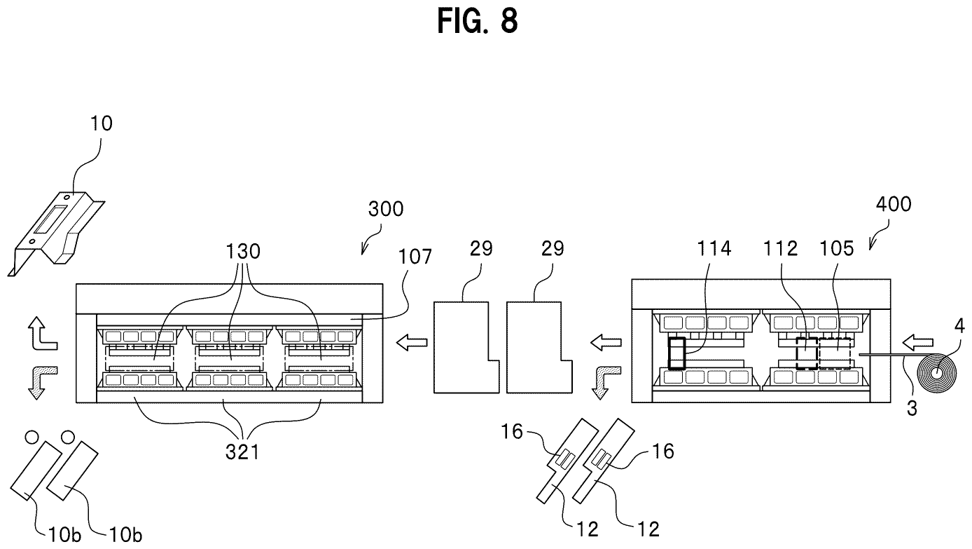

FIG. 8 shows a metal processing system of a fifth embodiment. Note that parts identical or equivalent to those of the first embodiment are denoted by the same reference signs, and different parts will be mainly described. In the fifth embodiment, the test specimen portion former 105, the material characteristic tester 112, and the cutter 114 are included in the first press-working machine 100. The fifth embodiment is different from the first embodiment in that a plurality of dies which operate integrally, or portions which execute the respective steps, can be separately mounted on and detached from the first press-working machine 100.

In the fifth embodiment configured in this way, the first press-working machine 100 executes each step of forming a forming target portion 29, which will be the product 10, in one cycle. Each die or portion which executes each step can be individually mounted and detached, so that the maintainability is favorable.

The other configurations as well as actions and effects are almost the same as those of the first embodiment, and thus are not described.

### Sixth Embodiment

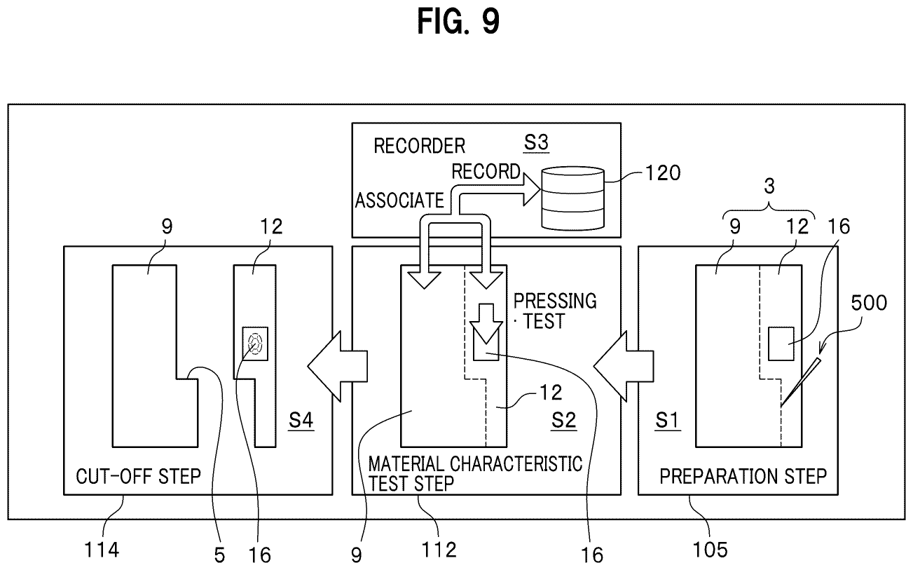

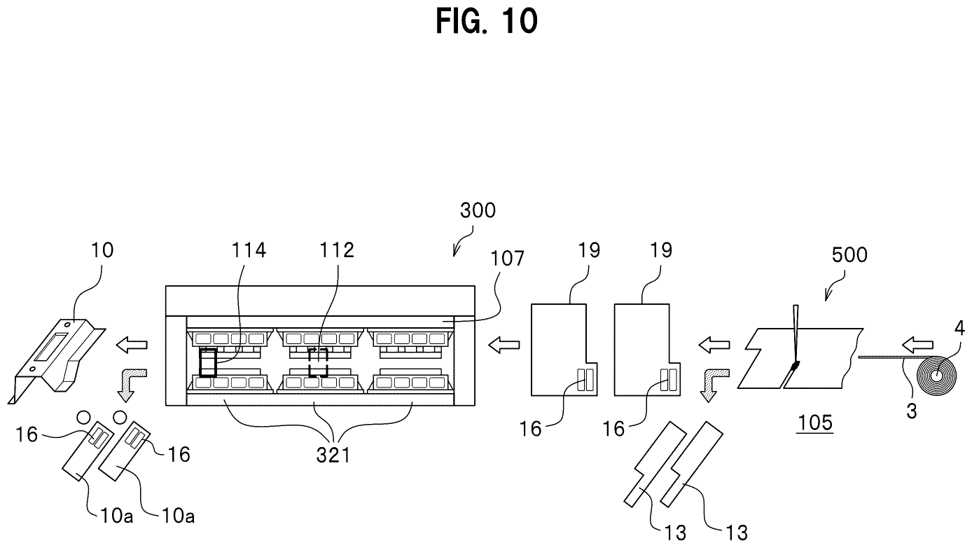

A metal processing system of a sixth embodiment shown in FIG. 9 and FIG. 10 includes a laser processing apparatus 500 in the test specimen portion former 105 which executes the preparation step.

In the sixth embodiment, the test specimen portion 16 can be formed in a part of the forming target portion 19, which will be the scrap portion 10a, by the laser processing apparatus 500.

For this reason, a plurality of dies 321 provided with the material characteristic tester 112 which executes the measurement of the test specimen portion 16, the press former, and the cutter 114 can be disposed in the single second press-working machine 300. Therefore, the material characteristic test step, the press working step, and the cut-off step can be simultaneously executed by a single opening and closing drive in the single second press-working machine 300, and an increase in manufacturing facility can be suppressed.

The other configurations as well as actions and effects are almost the same as those of the first to fifth embodiments, and thus are not described.

### Seventh Embodiment

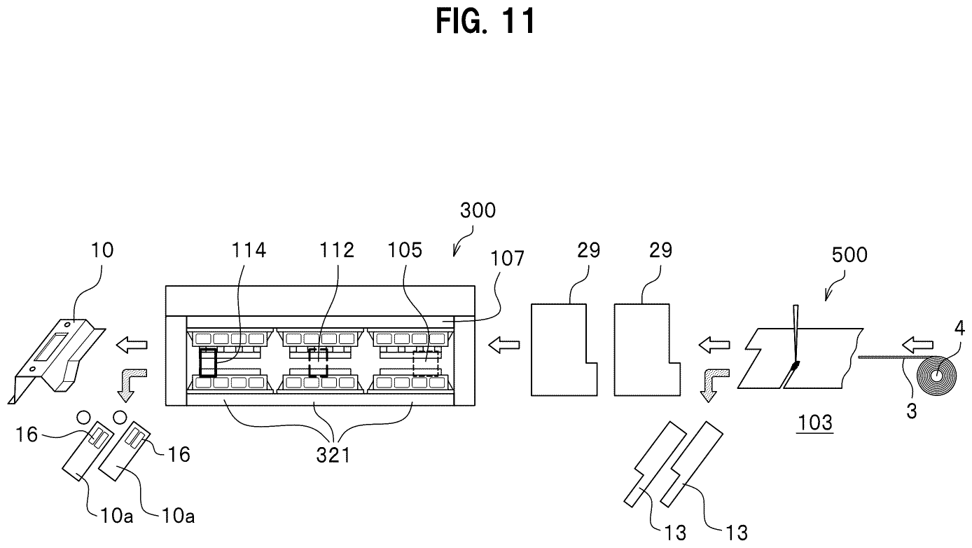

FIG. 11 shows a metal processing system of a seventh embodiment. Note that parts identical or equivalent to those of the first to sixth embodiments are denoted by the same reference signs, and different parts will be mainly described.

In the metal processing system of the seventh embodiment, the laser processing apparatus 500 cuts out the forming target portion 29 from the raw material 3 in the forming target portion former 103 as a part of the preparation step.

In addition, the test specimen portion former 105 is further provided in the second press-working machine 300 in addition to the second press-working machine 300 in the sixth embodiment. In the test specimen portion former 105, the test specimen portion 16 can be formed in a part which will be the scrap portion 10a.

In the seventh embodiment configured in this way, the test specimen portion 16 is formed in a part which will be the scrap portion 10a, by the test specimen portion former 105 included in the second press-working machine 300.

For this reason, the test specimen portion forming step, the material characteristic test step, the press working step, and the cut-off step can be simultaneously executed by a single opening and closing drive in the single second press-working machine 300.

The other configurations as well as actions and effects are almost the same as those of the first to sixth embodiments, and thus are not described.

As described above, the metal processing method and the metal processing system of the embodiments comprise the preparation step S1 of preparing the raw material 3 integrally including the forming target portion 9 which is press-formed to be the product 10, the scrap portion 12 which is eventually cut off from the forming target portion 9 to be a scrap, and the test specimen portion 16 which is provided in the scrap portion 12 and is subjected to the material characteristic test. The metal processing method comprises the material characteristic test step S2 of starting the material characteristic test by pressing the test specimen portion 16 in a state where the forming target portion 9 and the scrap portion 12 have not been cut off. Then, the metal processing method comprises: the recording step S3 of recording measurement data of the material characteristic test step S2 in association with the forming target portion 9; and the cut-off step S4 of cutting off the forming target portion 9 and the scrap portion 12 from each other.

The metal processing method and the metal processing system of the embodiments configured as described above record the measurement data of the test specimen portion 16 measured in the material characteristic test step S2 in association with the forming target portion 9 disposed adjacent thereto before cut-off.

For this reason, it is possible to virtually measure the material characteristics of a material which will be the product 10, and narrow the cause of generation of a defective product, thereby improving the productivity.

In addition, the preparation step comprises the test specimen portion forming step of conducting processing of a predetermined shape on the scrap portion 12 to form the test specimen portion 16.

As shown in FIG. 1, in the preparation step, the test specimen portion 16 is formed in the scrap portion of the raw material 3 in the test specimen portion former 105 which conducts the test specimen portion forming step. The test specimen portion former 105 moves toward and away from the raw material 3 to process the test specimen portion 16 during one cycle in which the first press-working machine 100 causes the driver 110 to close the die 111 once. For this reason, the number of processing steps or the distance in which a raw material is moved does not increase, so that the productivity does not decrease.

At least two steps among the test specimen portion forming step, the material characteristic test step, and the cut-off step are executed on each raw material 3 placed in each step in one cycle in the first press-working machine 100.

Therefore, an increase in the number of the first press-working machine 100 can be suppressed.

In addition, the first press-working machine 100 shown in FIG. 1 can conduct the press working and the measurement test simultaneously in three portions, that is, the test specimen portion former 105, the material characteristic tester 112, and the cutter 114 in one opening and closing drive in the first die 111.

For this reason, an increase in the number of the first press-working machine 100 can be further suppressed.

In addition, as shown in FIG. 6, the metal processing system 1 includes the press forming step of press-forming the forming target portion 19. The material characteristic test step is conducted simultaneously with the press forming step in one cycle in the press-working machine.

Therefore, an increase in the number of the press-working machine can be suppressed.

Moreover, the material characteristic tester 112 shown in FIG. 2 can simultaneously measure the material characteristics of the test specimen portion 16 by executing the die clamping action including the press forming step of conducting the press working or the test specimen portion forming step of forming the test specimen portion 16, or the like. Therefore, another apparatus that presses the test specimen portion or the like becomes unnecessary, and the number of apparatuses can be reduced, so that the cost can be suppressed.

In addition, as shown in FIGS. 9 to 11, in the test specimen portion forming step, the test specimen portion 16 can be formed in the scrap portion 10a by using the laser processing apparatus 500 which forms the test specimen portion 16 having a predetermined shape in the scrap portion 10a in the preparation step.

For this reason, the test specimen portion 16 having high precision can be easily formed.

In addition, for example, the test specimen portion 16 can be processed by using the same laser processing apparatus 500 as the laser processing apparatus 500 which forms a cut line extending along the external shape of the forming target portion. For this reason, it is unnecessary to provide a laser processing apparatus 500 dedicated to processing the test specimen portion 16.

Moreover, the metal processing system 1 of the first embodiment includes the transporter 104 which transports the raw material 3 from the material characteristic tester 112 to the cutter 114. In the metal processing system 1 of the first embodiment shown in FIG. 1, the first transporter 104a sequentially transports the raw material 3, which is pulled out of the uncoiler 4, to the test specimen portion former 105, the material characteristic tester 112, and the cutter 114 of the first press-working machine 100.

This allows the first press-working machine 100 to conduct the processing and measurement test simultaneously in three portions, that is, the test specimen portion former 105, the material characteristic tester 112, and the cutter 114 in a single press forming in the first die 111.

In addition, the metal processing system 1 shown in FIG. 1 further includes the second transporter 104b. The second transporter 104b transports a plurality of intermediate products 11, from each of which the scrap portion 12 has been separated in the first press-working machine 100, to the second press-working machine 200. The intermediate products 11 are each press-formed in the second die 121 by the opening and closing drive of the driver 210 of the second press-working machine 200 and processed to be a plurality of products 10. In this way, the production can be conducted without lowering the workability.

Then, as shown in FIG. 5, the driver includes the first press-working machine 100 which moves the material characteristic tester 112 toward and away from the raw material 3, and the second press-working machine 300 which moves the cutter 114 toward and away from the raw material 3. The first press-working machine 100 and the second press-working machine 300 have the first driver 110 and the second driver 210 (see FIG. 1).

For this reason, the material characteristic test and the cut-off can be executed by using the different drivers 110 and 210.

Moreover, as shown in FIG. 6, the metal processing system includes the press former 130 which press-forms the forming target portion 19. Then, the material characteristic tester 112 presses the test specimen portion 16 to conduct the material characteristic test at the same timing as the press-forming of the forming target portion 19 by the press former 130.

In this way, when the die forms the product 10, material characteristics equivalent to those of the raw material 3 constituting the product 10 can be simultaneously measured in one opening and closing drive in the second press-working machine 300.

The present invention is not limited to the above-described embodiments, and various modifications are possible. The above-described embodiments are shown as examples for describing the present invention in an easily understandable manner, and are not necessarily limited to those including all the described configurations. In addition, it is possible to replace part of a configuration of a certain embodiment with a configuration of another embodiment, and it is also possible to add a configuration of another embodiment to a configuration of a certain embodiment. In addition, it is possible to delete part of a configuration of each embodiment, or add or replace with another configuration. Modifications that can be made on the above-described embodiments are as described below, for example.

In the first embodiment, the cutter 114 which conducts the cut-off step S4 is included in the first press-working machine 100 as shown in FIG. 1. In addition, in the second embodiment, the cutter 114 which conducts the cut-off step is provided in the second press-working machine 300 as shown in FIG. 5.

However, the configuration is not particularly limited to these, and by providing another press-working machine or laser processing machine or the like besides the first press-working machine 100 and the second press-working machine 300, a cutter may be configured with the other press-working machine or laser processing machine.

For example, another press-working machine or the like may be provided between the first press-working machine 100 and the second press-working machine 300 to cut off the scrap portion 10a with a cutter of the other press-working machine or the like when transported from the first press-working machine 100 to the second press-working machine 300.

In addition, for example, another press-working machine or the like may be provided in a step following the second press-working machine 300 to cut off the scrap portion 10a with a cutter of the other press-working machine or the like when transported out of the second press-working machine 300.

Note that the recorder 220 may be provided in the second press-working machine 200 like the first press-working machine 100 (see FIG. 1). Then, the metal processing system 1 causes the recorder 120 of the first press-working machine 100 and this recorder 220 to cooperate. This allows the recorder 220 to record measurement data of the product 10 associated with the opening and closing drive from the driver 210 and the deformation amount measurer 240. Then, the measurement data of the test specimen portion 16 stored in the recorder 120 can be directly associated with each product 10.

For this reason, the cause of generation of defective products detected during manufacture can be easily narrowed further in addition to the case where the measurement data is associated with the intermediate product 11.

Moreover, although in the first embodiment, the press former 130 is provided in the second press-working machine 200 as shown in FIG. 1, the configuration is not particularly limited to this. For example, the press former 130 may be provided in the first press-working machine 100. In this case, the metal processing system of the invention of the present application can be constructed in the single first press-working machine 100, and an increase in the manufacturing cost can be suppressed.

In addition, a plurality of each of the test specimen portion former 105, the material characteristic tester 112, the cutter 114, or the press former 130, or portions which execute the respective steps may be provided in any press-working machine or the like. Hence, the numbers, quantities, shapes, and combinations of the press-working machines, dies, and the steps are not limited by the metal processing systems of the first to seventh embodiments. That is, the press working system may be in any combination as long as the press working system has the recording step of recording measurement data in the material characteristic test step in association with the forming target portion 9.

Then, although the embodiments in which the leveler feeder and the like are included in the first transporter 104a and the conveyor and the like are included in the second transporter 104b have been described, the configuration is not particularly limited to this. That is, any transporting apparatus may be employed as long as the transporting apparatus transports the raw material 3 or the like at any position such as between the material characteristic tester and the cutter, before or after any step, or the like in the metal processing system. For example, any transporting apparatus such as a forklift, various types of feeders, or fingers which transport between a plurality of dies supported on a single press-working machine or steps thereof, or the like may be employed.

### REFERENCE SIGNS LIST

3 raw material
9 forming target portion
10 product
11 intermediate product
12 scrap portion
16 test specimen portion
S1 preparation step
S2 material characteristic test step
S3 recording step
S4 cut-off step

1. A metal processing method comprising:
a preparation step of preparing a raw material integrally including a forming target portion which is press-formed to be a product, a scrap portion which is eventually cut off from the forming target portion to be a scrap, and a test specimen portion which is provided in the scrap portion and is subjected to a material characteristic test;
a material characteristic test step of starting the material characteristic test by pressing the test specimen portion in a state where the forming target portion and the scrap portion have not been cut off from each other;
a recording step of recording measurement data of the material characteristic test step in association with the forming target portion; and
a cut-off step of cutting off the forming target portion and the scrap portion from each other.

2. The metal processing method according to claim 1, wherein the preparation step comprises a test specimen portion forming step of conducting processing of a predetermined shape on the scrap portion to form the test specimen portion.

3. The metal processing method according to claim 2, wherein at least two steps among the test specimen portion forming step, the material characteristic test step, and the cut-off step are executed on each raw material placed in each step in one cycle in the press-working machine.

4. The metal processing method according to claim 2, wherein the test specimen portion forming step, the material characteristic test step, and the cut-off step are executed on each raw material placed in each step in one cycle of the press-working machine.

5. The metal processing method according to claim 1, further comprising a press forming step of press-forming the forming target portion, wherein
the material characteristic test step is conducted simultaneously with the press forming step.

6. The metal processing method according to claim 1, wherein the material characteristic test step measures at least one of a reaction force or a deformation amount generated by pressing the test specimen portion formed into a predetermined shape as the measurement data.

7. The metal processing method according to claim 2, wherein in the test specimen portion forming step, the test specimen portion is formed in the scrap portion by using a laser processing apparatus.

8. A metal processing system which conducts press-forming on a raw material integrally including a forming target portion which is press-formed to be a product, a scrap portion which is eventually cut off as a scrap from the forming target portion, and a test specimen portion which is provided in the scrap portion and is subjected to a material characteristic test, comprising:
a material characteristic tester which conducts a material characteristic test by pressing the test specimen portion in a state where the forming target portion and the scrap portion have not been cut off from each other;
a recorder which records measurement data of the material characteristic tester in association with the forming target portion;
a cutter which cuts off the forming target portion recorded by the recorder and the scrap portion; and
a driver which moves the material characteristic tester and the cutter toward and away from the raw material.

9. The metal processing system according to claim 8, further comprising a test specimen portion former which conducts processing of a predetermined shape on the scrap portion to form the test specimen portion, wherein
the driver moves the test specimen portion former toward and away from the raw material.

10. The metal processing system according to claim 9, wherein in at least two among the test specimen portion former, the material characteristic tester, and the cutter, the test or the processing is executed on each raw material placed therein in one cycle by the driver.

11. The metal processing system according to claim 9, wherein the test or the processing of the test specimen portion former, the material characteristic tester, and the cutter is conducted on each raw material placed therein in one cycle by the driver.

12. The metal processing system according to claim 8, wherein the material characteristic tester includes: a pressing portion which presses the test specimen portion formed into a predetermined shape; and a deformation amount measurer which measures at least one of a reaction force or a deformation amount generated by pressing the test specimen portion as measurement data.

13. The metal processing system according to claim 8, further comprising a transporter which transports the raw material from the material characteristic tester to the cutter.

14. The metal processing system according to claim 8, wherein the driver includes: a first driver which moves the material characteristic tester toward and away from the raw material; and a second driver which moves the cutter toward and away from the raw material.

15. The metal processing system according to claim 8, further comprising a press former which press-forms the forming target portion, wherein
the material characteristic tester presses the test specimen portion to conduct the material characteristic test at the same timing as the press-forming of the forming target portion by the press former.

16. The metal processing system according to claim 8, further comprising a test specimen portion former which conducts processing of a predetermined shape on the scrap portion to form the test specimen portion, wherein
the test specimen portion former includes a laser processing apparatus which forms the test specimen portion in the scrap portion.
